(19) United States
(12) Patent Application Publication
(10) Pub. No.: US 2010/0011863 A1
(43) Pub. Date: Jan. 21, 2010

(54) METHOD AND APPARATUS FOR COMPUTED TOMOGRAPHY

(75) Inventor: Matthew Richard William Hogbin, Hertfordshire (GB)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: The Secretary of State for Home Affairs, London (GB)

(21) Appl. No.: 12/304,775

(22) PCT Filed: Jun. 14, 2007
(86) PCT No.: PCT/GB2007/002228

§ 371 Date: Jan. 23, 2009

(30) Foreign Application Priority Data
Jun. 14, 2006 (GB) 0611767.5

(51) Int. Cl. G01N 29/27; G01N 23/00; H05G 1/00

(52) U.S. Cl. 73/618; 378/20; 250/393

(57) ABSTRACT

An apparatus for performing tomographic imaging of an object comprising means for conveying the object through a first imaging means and a second imaging means which are static relative to the conveying means and are comprised of at least one source and detector. The source illuminates the detector with a beam to obtain a tomographic slice with the tomographic slice of the first and second imaging means being coplanar. Between the two imaging means the movement involves a change of direction of motion of the object in the same plane as the tomographic slice whilst maintaining the objects orientation relative to the apparatus.

Tomography involves the generation of a two-dimensional image representing a slice or section through a three-dimensional object. The method is used in medicine, archaeology, biology, geology, materials science and various other sciences. Tomographic imaging is also used for detection, for example, of concealed threats or contraband and for defects in articles such as in manufacture. Tomograms are most usually derived using x-rays, gamma rays or ultrasound, however, using current technology, known in the art, other physical phenomena including positron electron annihilation reaction, nuclear magnetic resonance, electrons, and ions or combinations of these various physical phenomena can also be used.

Methods of Computer Tomography are grouped into parallel-beam, fan-beam, and cone-beam techniques. Parallel-beam systems use planewave illumination. Fan-beam systems use rays projected from a point source in a planar slice. Cone-beam systems employ rays projected in a 3-D solid angle from a point source.

Tomographic imaging requires that multiple coplanar projection views of the object of interest are obtained, the data from which are combined to determine certain properties of the materials within the slice, from which an image can be constructed or some internal structure of potential interest can be identified.

To obtain multiple coplanar projection views of an object, tomographic imaging systems often employ a rotating source(s) and detector, within which the object to be inspected is held. By this method, projections are acquired through the object from a range of coplanar viewpoints.

This requires the source and detector to be mounted on a rotating gantry which results in a complex and expensive system. In many cases the object must also be stopped in order to obtain multiple accurate coplanar views from which a tomographic image can be constructed and can limit the throughput of the system. Stoppages of this kind can be particularly problematic where the minimising of potential delays can be vital especially in applications such as airport baggage scanners.

For example, US patent application US2004/0101097 relates to a low price detection system for use in airports that utilises x-ray computerised tomography employing a rotating source and detector array assembly. U.S. Pat. No. 6,256,404 relates to a method and apparatus intended to increase the efficiency of the process of CT baggage scanning at airports though the use of a rotating source and detector array assembly with a data reconstruction window which can be adapted to scan only the area of the object.

It is an object of the present invention to provide a system of tomographic imaging that reduces the cost and complexity of the machinery through the use of stationary source and detector assemblies and maximises efficiency by allowing for continuous throughput of the object(s) to be examined.

Accordingly there is provided an apparatus for performing tomographic imaging of an object comprising means for conveying the object through a first imaging means and a second imaging means which are static relative to the conveying means and are comprised of at least one source and detector wherein the source illuminates the detector with a beam to obtain a tomographic slice with the tomographic slice of the first and second imaging means being coplanar; characterised in that between the two imaging means the movement involves a change of direction of motion of the object in the same plane as the tomographic slice whilst maintaining the objects orientation relative to the apparatus.

In a further embodiment any number of differing image orientations can be achieved through an apparatus comprised of a conveying means suitable for conveying the object through any number of imaging means which are static relative to the conveying means and are comprised of at least one source and detector wherein the source illuminates the detector with a beam to obtain a tomographic slice with the tomographic slice of the first and all subsequent imaging means being coplanar; characterised in that between each subsequent imaging means the movement involves a change of direction of motion of the object in the same plane as the tomographic slices whilst maintaining the objects orientation relative to the apparatus.

A further embodiment of the apparatus employs a section of conveying means to provide the change of direction of motion of the object, separate to the conveying means used to provide the initial motion of the object, whilst maintaining the objects orientation relative to the apparatus.

A preferred embodiment in which a plurality of separate sections of conveying means are used to provide the change of direction of motion of the object separate to the conveying means used to provide the initial motion of the object gives the advantage that continuous conveying of multiple objects through the apparatus can be maintained.

The conveying means can be comprised of a conveyor belt, a lift, a carousel or any other device suitable for moving an object whilst maintaining its initial orientation relative to the apparatus or any combination thereof.

The change of direction of motion of the object can also be achieved by an apparatus in which each object is located upon a separate container means which is conveyed through the apparatus enabling the objects orientation relative to the apparatus to be maintained.

In a preferred embodiment the imaging means are comprised of a plurality of sources and detectors suitable for simultaneously acquiring multiple tomographic slices

In a further embodiment the imaging means is comprised of at least one source and detector wherein the source illuminates the detector with a fan beam.

In a further embodiment the imaging means is comprised of at least one source and detector wherein the source illuminates the detector with a parallel beam.

In a further embodiment the imaging means is comprised of at least one source and detector wherein the source illuminates the detector with a cone beam suitable for simultaneously acquiring multiple tomographic slices with a single source

The data collected by the tomographic imaging apparatus can be used to calculate an estimate of the mass density throughout an object and an estimate of the mass density and atomic number throughout an object.

The apparatus can employ any current or future tomographic imaging technology utilising a variety of physical phenomena as described in paragraph 1 or any combination thereof.

Accordingly there is a method for performing tomographic imaging of an object comprising means for conveying the object through a first imaging means and a second imaging means which are static relative to the conveying means and are comprised of at least one source and detector wherein the source illuminates the detector with a beam to obtain a tomographic slice with the tomographic slice of the first and second imaging means being coplanar; characterised in that between the two imaging means the movement involves a change of direction of motion of the object in the same plane as the tomographic slice whilst maintaining the objects orientation relative to the apparatus

In a further embodiment of the method comprised of a conveying means suitable for conveying the object through any number of imaging means which are static relative to the conveying means and are comprised of at least one source and detector wherein the source illuminates the detector with a beam to obtain a tomographic slice with the tomographic slice of the first and all subsequent imaging means being coplanar; characterised in that between each subsequent imaging means the movement involves a change of direction of motion of the object in the same plane as the tomographic slices whilst maintaining the objects orientation relative to the apparatus.

In a further embodiment of the method the imaging means are comprised of a plurality of sources and detectors suitable for simultaneously acquiring multiple tomographic slices.

In a further embodiment of the method the imaging means is comprised of at least one source and detector wherein the source illuminates the detector with a fan beam, a parallel beam or a cone beam to obtain multiple tomographic slices with a single source.

The invention is now described further and explained in more detail with reference to an exemplary embodiment shown in the drawings wherein:

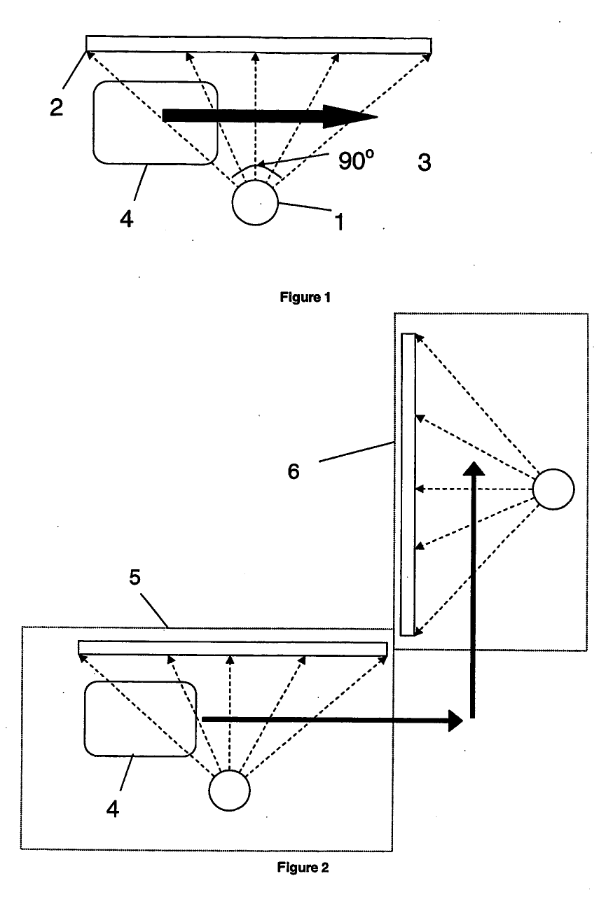

FIG. 1 shows a simplified diagram of an object passing through a single source and detector assembly.

FIG. 2 shows an arrangement of a first and second source and detector assembly and the motion of the object through both to obtain two planar segment images.

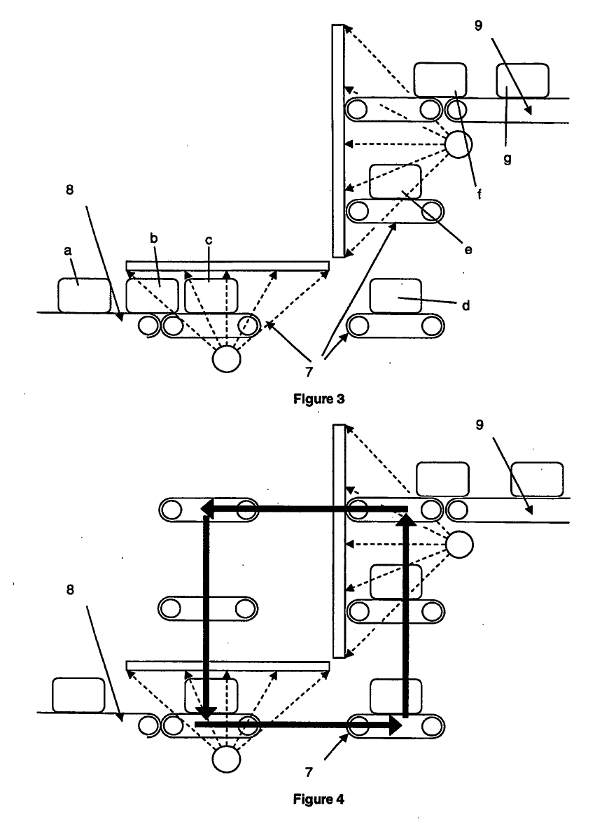

FIG. 3 depicts an arrangement of two source and detector assemblies and the use of in-feed and out-feed conveyors and a carrier to produce the required motion and change of direction of motion.

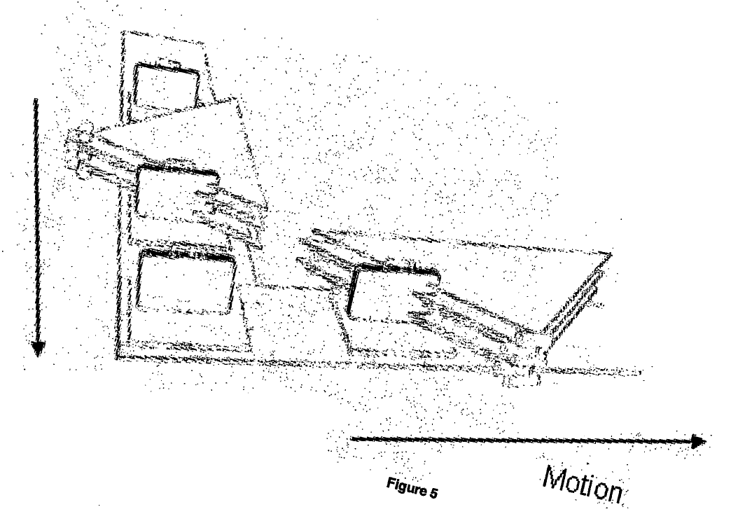

FIG. 4 illustrates how an arrangement as in FIG. 3 may employ a number of carriers to maintain continuous conveying of multiple objects.

FIG. 5 an alternate embodiment to that shown in FIGS. 3 & 4 and the use of more than one source-detector assembly to simultaneously acquire several tomographic slices.

A non-limiting example is embodied in a tomographic imaging system utilizing a stationary source-detector assembly in which the source illuminates a detector with a fan beam, such that the angle between rays falling on the detectors at the two extremes of the array is 90 degrees.

The object first passes through one such source-detector assembly in a direction parallel to the detector. The objects direction of travel is then changed such that it now travels in a direction different to its initial direction of travel but which still falls within the plane of the fan beam of the initial source. This change in direction of motion is executed whilst maintaining the initial orientation of the object.

In this subsequent direction of motion the object then passes through a further source-detector assembly which is orientated such that the fan beam lies within the same plane as that of the previous source but obtains a differing projection view.

This may be followed by yet further subsequent steps to obtain as many projection views as required.

As a non-limiting example, the imaging system detector can be formed from a linear array of detectors or from a single continuous detector monitored by a position sensitive read out, to provide the position sensitive projection data for reconstruction. The source generates a fan beam that emanates from the source, passes through a planar imaging field, and is received by the detectors.

In FIG. 1 a source (1) illuminates a detector (2) as shown, with a fan beam (3), such that the angle between rays falling on the two extremes of the detector is 90 degrees.

Two such systems are oriented at an angle of 90 degrees to one another, with the fan beams lying in the same plane.

In FIG. 2 the object (4) first passes through one such system (5) in a direction parallel to the detector. The object then changes direction to travel at 90 degrees to the original direction of motion, and within the plane of the fan beam.

The object then passes through a second source/detector system (6). In this way, 180 degrees of parallel projection data are acquired for the object under inspection, which allows tomographic reconstruction.

Angles other than 90 degrees may be used—i.e. 3 assemblies of 60 degrees each, 6 assemblies of 30 degrees each.

Arrangements whereby the angles subtended by the detectors at the sources sum to more than 180 degrees can be used. It is also possible to use arrangements where these angles sum to less than 180 degrees although this does lead to incomplete projection data, in which case, reconstruction can be achieved with a certain level of artifacts which can then be reduced by mathematical means.

A practical but non-limiting implementation is shown in FIG. 3 which involves the use of a caddy or carrier to accomplish the required change in direction of the objects to be inspected whilst maintaining their original orientation. The carrier (7) may be equipped with a small section of conveyor. The sequence of events is as follows:
a) The object travels into the system on the in-feed conveyor (8)
b) The object is transferred to the carrier (7) by the action of the in-feed and carrier conveyor belts together.
c) The carrier transports object through first source/detector assembly.
d) The carrier changes direction.
e) The carrier transports object through second source/detector assembly.
f) The object is transferred to out feed conveyor by the action of carrier and out-feed conveyors together.
g) The object is transported out of the system by the out-feed conveyor (9).

In order to examine objects continuously, more than one carrier may be employed, as in FIG. 4. After step g) in FIG. 3, the empty carrier is circulated back to the in feed conveyor by a mechanical transport system. This can occur while other caddies are transporting object(s) through the imaging process.

In FIG. 5 an alternate embodiment to that shown in FIGS. 3 & 4, motion takes place in a plane parallel to the surface of the conveyor belt system—for instance horizontally—where the source-detector assemblies are arranged such that the fan beams lie in a plane parallel to the conveyor.

FIG. 5 also depicts the use of more than one source-detector assembly to simultaneously acquire several tomographic slices with a single pass through the system, with each source-detector assembly being oriented with the fan beam parallel to that of the first assembly pair.

The use of a two-dimensional area detector, typically an array formed from multiple rows and columns of individual detectors and illuminated by a cone beam emanating from the source, can also be used to acquire multiple image slices simultaneously.

1. An apparatus for performing tomographic imaging of an object comprising means for conveying the object through a first imaging means and a second imaging means which are static relative to the conveying means and are comprised of at least one source and detector wherein the source illuminates the detector with a beam to obtain a tomographic slice with the tomographic slice of the first and second imaging means being coplanar; wherein between the two imaging means the movement involves a change of direction of motion of the object in the same plane as the tomographic slice while maintaining the orientation of the object relative to the apparatus.

2. The apparatus as in claim 1 comprising a conveying means suitable for conveying the object through any number of imaging means which are static relative to the conveying means and are comprised of at least one source and detector wherein the source illuminates the detector with a beam to obtain a tomographic slice with the tomographic slice of the first and all subsequent imaging means being coplanar; wherein between each subsequent imaging means the movement involves a change of direction of motion of the object in the same plane as the tomographic slices while maintaining the orientation of the object relative to the apparatus.

3. The apparatus as in claim 1 in which a separate conveying means provides the change of direction of motion of the object while maintaining the orientation of the object relative to the apparatus.

4. The apparatus as in claim 3 in which a plurality of separate conveying means are employed to maintain continuous conveying of multiple objects through the apparatus.

5. The apparatus as in claim 1 in which each object is located upon a separate container means to be conveyed through the apparatus and suitable for maintaining the orientation of the object relative to the apparatus during the change of direction of motion of the object.

6. The apparatus as in claim 1 in which the imaging means are comprised of a plurality of sources and detectors suitable for simultaneously acquiring multiple tomographic slices.

7. The apparatus as in claim 1 in which the imaging means is comprised of at least one source and detector wherein the source illuminates the detector with a fan beam.

8. The apparatus as in claim 1 in which the imaging means is comprised of at least one source and detector wherein the source illuminates the detector with a parallel beam.

9. The apparatus as in claim 1 in which the imaging means is comprised of at least one source and detector wherein the source illuminates the detector with a cone beam suitable for simultaneously acquiring multiple tomographic slices with a single source.

10. The apparatus as in claim 1 in which the data collected by the imaging means is used to calculate an estimate of the mass density throughout an object.

11. The apparatus as in claim 1 in which the data collected by the imaging means is used to calculate an estimate of the mass density and atomic number throughout an object.

12. The apparatus as in claim 1 in which said imaging means utilise x-rays.

13. The apparatus as in claim 1 in which said imaging means utilise gamma rays.

14. The apparatus as in claim 1 in which said imaging means utilise ultrasound.

15. A method for performing tomographic imaging of an object comprising means for conveying the object through a first imaging means and a second imaging means which are static relative to the conveying means and are comprised of at least one source and detector wherein the source illuminates the detector with a beam to obtain a tomographic slice with the tomographic slice of the first and second imaging means being coplanar; characterised in that between the two imaging means the movement involves a change of direction of motion of the object in the same plane as the tomographic slice while maintaining the orientation of the object relative to the apparatus.

16. The method as in claim 19 comprising a conveying means suitable for conveying the object through any number of imaging means which are static relative to the conveying means and are comprised of at least one source and detector wherein the source illuminates the detector with a beam to obtain a tomographic slice with the tomographic slice of the first and all subsequent imaging means being coplanar; wherein between each subsequent imaging means the movement involves a change of direction of motion of the object in the same plane as the tomographic slices while maintaining the orientation of the object relative to the apparatus.

17. The method as in claim 15 in which the imaging means are comprised of a plurality of sources and detectors suitable for simultaneously acquiring multiple tomographic slices.

18. The method as in claim 15 in which the imaging means is comprised of at least one source and detector wherein the source illuminates the detector with a fan beam.

19. The method as in claim 15 in which the imaging means is comprised of at least one source and detector wherein the source illuminates the detector with a parallel beam.

20. The method as in claim 15 in which the imaging means is comprised of at least one source and detector wherein the source illuminates the detector with a cone beam suitable for simultaneously acquiring multiple tomographic slices with a single source.
